(19) United States
(12) Patent Application Publication
(10) Pub. No.: US 2026/0086958 A1
(43) Pub. Date: Mar. 26, 2026

(54) SYSTEM AND METHOD FOR EMULATING A CHIPSET ON A SYSTEM

(71) Applicant: CIMware Technologies Pvt. Ltd., Bangalore (IN)

(72) Inventor: Rajiv Ganth, Bangalore (IN)

(21) Appl. No.: 19/266,232

(22) Filed: Jul. 11, 2025

(30) Foreign Application Priority Data
Sep. 24, 2024 (IN) 202441072220
May 27, 2025 (IN) 202544050746

(51) Int. Cl. G06F 13/16; G06F 13/42

(52) U.S. Cl. CPC G06F 13/1663; G06F 13/4221; G06F 2213/0026

(57) ABSTRACT

A method for provisioning more than one emulated device from a host computer system (CS) comprises providing PCIe-NTB devices on the CS. Each PCIE-NTB device comprises a PCIe port that is configured to connect to an external computer system (EC), using PCIe cables. The method comprises running an emulation software on CPU cores of the CS to emulate the chipset on the CS; and lending the emulated chipset to the PCIe-NTB connected EC. Lending the emulated chipset to the PCIe-NTB connected EC comprises allocating a contiguous memory space in a memory unit of the CS and/or in a memory unit of the EC for use by the emulated chipset. The step of lending the emulated chipset to the PCIe-NTB connected EC comprises provisioning mapping of the allocated contiguous memory space of the emulated chipset to the memory of the EC for configuration and use of the emulated chipset by EC.

### CROSS-REFERENCE TO RELATED APPLICATIONS

This application claims priority to and the benefit of the non-provisional patent application titled “System And Method For Emulating A Chipset On A System”, application No. 202544050746, filed in the Indian Patent Office on May 27, 2025 which claim priority and the benefit of the provisional patent application titled “System And Method For Emulating A Chipset On A System”, application No. 202441072220, filed in the Indian Patent Office on Sep. 24, 2024. The specifications of the above referenced patent applications are incorporated herein by reference in their entirety.

### FIELD OF THE INVENTION

The present invention, in general, relates to hardware adaptability. More particularly, the present invention relates to implementing host of functionalities of multiple controllers on computer system and provisioning them through peripheral component interconnect express (PCIe) non-transparent bridge technology, to improve data centre infrastructure to be hyper-scalable and high-performance composable disaggregated infrastructure without having to rewrite existing applications and without changing infrastructure architecture/deployment.

### BACKGROUND OF THE INVENTION

A chip can either be an Input/Output (IO) device such as (ether) network Controller or an ethernet controller, Fibre Channel Controller, serial attached SCSI (SAS), serial advanced technology attachment (SATA) controller or be (Ether/Fibre Channel) network switch. These devices are application specific Integrated Circuits (ASIC) and they are part of server system or a System-on-Chip (SoC). A chipset is a set of such chips/devices/ASICs.

A System-On-Chip (SoC) is an integrated circuit that integrates most or all components of a computer or another electronic system. These components almost always include at least one on-chip Central Processing Unit (CPU), memory interfaces, input/output (IO) devices and interfaces, and secondary storage interfaces, often alongside other components such as radio modems and a Graphics Processing Unit (GPU)—all on a single substrate or a microchip.

A computer system is a collection of multiple systems. There are sub-systems developed to perform one specific task continuously in perpetuity. Mostly, these sub-systems are hardware devices that communicate from/to a central processing unit (CPU) to/from other systems. Since each of these application-specific hardware devices is developed for only one application, they are referred to as application-specific integrated circuits (ASICs). For example, a network interface controller (NIC) is an ASIC that connects a CPU of a server and in turn, applications running on the CPU to another CPU or software system externally. A storage controller connects the CPU or the software system to a storage target device. These ASICs or controllers perform a mundane set of actions to complete the ultimate intention of communicating outside the system, or storing data, or performing additional computing. Some considerations comprise (1) simple and faster connectivity between the ASIC and the CPU; (2) a memory subsystem to work in tandem with both the ASIC and CPU; and (3) the ASIC must perform one set of actions.

Even though, these ASICs or controllers perform different applications that are intended, they have a common architecture. Mostly the architecture is a System-on-Chip (SoC) for commonly used network and storage controllers. FIG. 1A exemplarily illustrates a prior art architecture of a System-on-Chip (SoC). A SoC is an ASIC that integrates most or all components of a computer or another electronic system onto a single substrate or microchip. These components comprise, for example, one or more on-chip central processing units (CPUs), a memory interface, input/output (IO) controller devices and interfaces, and secondary storage interfaces, often alongside other components such as media access controllers (MAC) and graphics processing unit (GPU). The SoC may contain digital, analog, and mixed-signal functions. Higher performance SoCs are often paired with a dedicated and physically separate memory and secondary storage chips, that may be layered on top of the SoC in a package-on-package (POP) configuration or be placed close to the SoC.

A SoC integrates a microcontroller, a microprocessor, or even several processor cores with peripherals such as a GPU, one or more co-processors, etc. Similar to the integration of a microprocessor with peripheral circuits and memory into a microcontroller, the SoC integrates a microcontroller with additional, more advanced peripherals, for example, media access controllers (MACs). Compared to a multi-chip architecture, an SoC with equivalent functionality typically has reduced power consumption as well as a smaller semiconductor die area, which comes at the cost of reduced replaceability of components. SoC designs are fully or nearly fully integrated across different component modules. For example, SoCs are present in common mobile phones to higher end super computers as well. Furthermore, SoCs are used in server systems as particular IO controller devices or SoCs can be used as a main processor itself in a real time system like smart phone/mobile phone. SoCs are used to off-load data of the processing loads in server systems recently. Redundant Array of Independent Disks (RAID) controllers & Smart Network Interface Cards (NIC) are some of the examples for SoC, in server systems. In most instances, the SoC is connected to main CPU using PCIe. SoC presents itself as PCIe end-point.

At private and/or public cloud data centers, specialized Application-Specific Integrated Circuit (ASIC) SoCs are designed to specific functions, for example, network interface controllers (NICs), storage (virtualization) controllers, network switches, and storage arrays. These hardware silicon chips are highly complex based on the speed and number of ports that they support. Vendors of such SoCs are very few, which curbs the innovation in the technology era.

The SoCs contain a large number of low power CPUs, a high speed and low latency system bus, and media access controllers (MACs) for PCIe, NAND, SATA, SAS, where SCSI refers to small computer systems interface, Ethernet, etc. Keeping it simple helps to reuse the design and improve the throughput of the internal memory and connecting buses.

In such very well-defined and designed systems, the connecting bus is evolving to be a very low latency and wider bandwidth bus. Moreover, the design and development cost of SoCs is increasing. FIG. 1B illustrates the way of communication between a main memory 02 (Double Data Rate (DDR) memory) and input/output (IO) hardware (H/W) devices 03 and 04 in a computer system 01. The hardware (H/W) devices comprise, a Network Interface Controller (NIC) 04, a storage 03 attached to the motherboard of the computer system 01. Each H/W device 03 and 04 contains a System-on-a-Chip (SoC) (not shown) and needed amount of memory (not shown) on a Printed Circuit Board (PCB) (not shown) and the combination of the SoC and the needed amount of memory on the PCB is called, a Host Bus Adapter (HBA) (not shown). This HBA is connected to host CPU bus 05, Peripheral Component Interface (PCIe) Express bus 06, through provisions on the mother board of the computer system 01. The CPU 07 processes all input and output for the computer system 01. However, every H/W device 03 and 04 needs a HBA to communicate between the operating system and the CPU 07. A HBA is part of every H/W device 03 and 04 connected to the computer system 01. Whether a new storage 03 is attached to the motherboard or a new NIC 04 is attached to the motherboard, all H/W devices 03 and 04 have a HBA integrated on their PCB or use the HBA integrated with the computer system's 01 motherboard.

To communicate with the SoC on HBA or SoC of the HBA on mother board, the memory of SoC's is mapped to the main memory 02 of the computer system's CPU 07. The software (S/W) application (device driver) on the main CPU 07, reads & writes to mapped sections of the main memory 02 to control the SoC and to access data & status of the SoC. A DMA controller 08 is a hardware device used for direct memory access. It is a control unit, part of IO H/W device's 03 and 04 interface circuit, which can transfer blocks of data between IO H/W devices 03 and 04 and main memory 02 with minimal intervention from the processor 07. A memory controller 09, is a digital circuit that manages the flow of data going to and from the computer system's 01 main memory 02.

Thus, a computer system 01 has this common architecture to consistently perform the IO task to any IO H/W device 03 and 04 connected to it. The SoC might consist more than one media access controller (MAC) such as SAS, SATA, Fiber channel & Ethernet to connect to its target.

H/W SoC design, depends on the connection technology & topology. In modern days, the switched fabric or bridge to connect more than one system increases complexity of the design. Moreover, the data processing off-loading to SoC increases the requirement of compute power to the chip as well. Hence, the H/W controllers/ASIC are getting complex to design day by day.

Hence, there is a long-felt need for a system and a method for emulating a chipset on a host computer system that facilitate hardware adaptability in a computer device, where the chipset on the host computer system leverages a peripheral component interconnect express (PCIe) protocol for improving a data lifecycle and methods of networking and computing data without having to rewrite existing applications and without changing existing host and other system deployments.

### SUMMARY OF THE INVENTION

This summary is provided to introduce a selection of concepts in a simplified form that are further disclosed in the detailed description of the invention. This summary is not intended to determine the scope of the claimed subject matter.

The present invention addresses the above-recited need for a system and a method for emulating a “chipset on a system” (CoS) that facilitate hardware adaptability in a computer device. The chipset on the system (CoS) leverages a peripheral component interconnect express (PCIe) protocol for it as the means to connect peripheral devices such as IO controllers to a system's CPU. Hence, there is no need to rewrite existing applications and to change existing host and other system deployments.

The method for creating and provisioning more than one device from a computer system comprises of providing one or more peripheral component interconnect express non-transparent bridge (PCIe-NTB) devices on the computer system. As used herein, the term “chipset” in “chipset-on-a-system” refers to input/output (IO) controller devices & network switches and the term “system” refers to the “computer system”. Each of the PCIe-NTB devices comprise a peripheral component interconnect express (PCIe) port that is configured to connect to an external computer system, using one or more PCIe cables. As used herein, the term “computer system”, “host system”, “host computer”, “host computer system” refers to the host computer device that hosts the system that emulates the “chipset”. The host computer and the external computer system are selected from a group comprising a computer, a server, a portable computing device, etc. The method further comprises running an emulation software on one or more central processing unit (CPU) cores of the host computer to emulate the chipset on the host computer. The emulated chipset provisions functionalities of an input/output (IO) controller device. The method further comprises lending the emulated chipset to the external computer system connected through the PCIe-NTB device via a PCIe connection. The step of lending the emulated chipset to the external computer system connected through the PCIe-NTB device comprises allocating a contiguous memory space in a memory unit of the host computer system and/or in a memory unit of the external computer system. The contiguous memory space is for use of the emulated chipset. The step of lending the emulated chipset to the PCIe-NTB connected external computer system further comprises provisioning mapping of the allocated contiguous memory space of the emulated chipset to the memory of the external computer system for configuration and use of the emulated chipset by the external computer system.

In an embodiment, the method further comprises running one or more un-swapped finite state machine processes on the CPU cores to provide a hardware functionality and share the allocated contiguous memory space with the connected external computer system via the PCIe-NTB. In an embodiment, the hardware functionality provided or emulated by finite state machine processes would comprise functionality of one of a non-volatile memory express (NVMe) controller, a smart network interface controller, a network switch, a storage virtualization controller, etc.

A system for provisioning more than one device from a computer system comprises one or more peripheral component interconnect express non-transparent bridge (PCIe-NTB) devices. Each of the one or more PCIe-NTB devices comprise a peripheral component interconnect express (PCIe) port configured to connect to the external computer system/server, using one or more PCIe cables. The system for provisioning more than one emulated device from the computer system further comprises one or more central processing unit (CPU) cores running an emulation software to emulate a chipset on the computer system to lend the emulated chipset to the external computer system connected via the PCIe-NTB device. The emulated chipset emulates functionalities of an input/output (IO) controller device such as ethernet switches, Fibre Channel switches and IO controllers such as Network Interface Controllers and Fibre Channel controllers, NVMe controllers. These emulated devices are further provisioned to other computer systems/servers which are connected via the Non-Transparent Bridge of PCIe technology. A Non-Transparent Bridge (NTB) is a type of bridge that is used to connect two or more computer systems, allowing them to communicate with each other over a high-speed PCIe interconnect. NTBs are often used in high-performance computing (HPC) and data center environments to enable communication between multiple compute nodes or servers. By providing a high-speed interconnect between these systems, an NTB can enable faster data transfer and processing for compute-intensive workloads.

A computer system with PCIe-NTB device further comprises a memory unit operably and communicatively coupled to the plurality of CPU cores and configured to store computer program instructions executable by the plurality of CPU cores. The computer program instructions comprise instructions corresponding to the emulation software and the memory. The contiguous memory space is allocated by the program for use by the emulated chipset.

In an embodiment, the contiguous memory space is shared between the memory unit of the host computer system and the memory unit of the external computer system. In an embodiment, the emulated chipset may utilize the contiguous memory space as device memory of the emulated I/O controller on the host computer system. By sharing this ‘device memory’ over non-transparent bridge of PCIe to another embodiment, the PCIe connected external computer host system realizes the device as direct-attached-device through PCIe to itself.

The computer program instructions stored in the memory unit of the system comprise instructions to implement the un-swapped finite state machine process on the CPU cores. The un-swapped finite state machine process implements a hardware functionality and share the allocated contiguous memory space with the connected external computer system via the PCIe-NTB device.

In one or more embodiments, related systems comprise circuitry and/or programming for effecting the present invention. In an embodiment, the circuitry and/or programming are of any combination of hardware, software, and/or firmware configured to implement the present invention depending upon the design choices of a system designer. Also, in an embodiment, various structural elements are employed depending on the design choices of the system designer.

### BRIEF DESCRIPTION OF THE DRAWINGS

The foregoing summary, as well as the following detailed description of the invention, is better understood when read in conjunction with the appended drawings. For illustrating the present invention, exemplary constructions of the present invention are shown in the drawings. However, the present invention is not limited to the specific components, structures, and methods disclosed herein. The description of a component, or a structure, or a method step referenced by a numeral in a drawing is applicable to the description of that component, or structure, or method step shown by that same numeral in any subsequent drawing herein.

FIG. 1A exemplarily illustrates a prior art architecture of a System-on-Chip (SoC).

FIG. 1B illustrates the way of communication between a main memory (DDR memory) and hardware (H/W) devices in a computer system.

FIG. 2 illustrates a method for provisioning more than one emulated device from a computer system (CS).

FIG. 3 illustrates a block diagram of a system for provisioning more than one emulated device from a computer system (CS) and a block diagram of an external computer system, where both the host computer system and the external computer system are connected through a peripheral component interconnect express (PCIe) connection.

FIG. 4 exemplarily illustrates a prior art PCI Express topology, displaying the position of a PCIe Root Complex.

FIG. 5 exemplarily illustrates a Finite State Machine (FSM) running in one or more cores of a central processing unit (CPU) of the system for provisioning more than one emulated device from a computer system (CS).

FIG. 6 illustrates a peripheral component interconnect express (PCIe) non-transparent bridge (NTB) PCIe-NTB device.

FIG. 7 illustrates the scalability of the CoS.

### DETAILED DESCRIPTION OF THE INVENTION

Various aspects of the present disclosure are embodied as a system, a method, or a non-transitory, computer-readable storage medium having one or more computer-readable program codes stored thereon. Accordingly, various embodiments of the present disclosure herein take the form of an entirely hardware embodiment, an entirely software embodiment comprising, for example, microcode, firmware, software, etc., or an embodiment combining software and hardware aspects that are referred to herein as a “system”, a “module”, a “circuit”, or a “unit”.

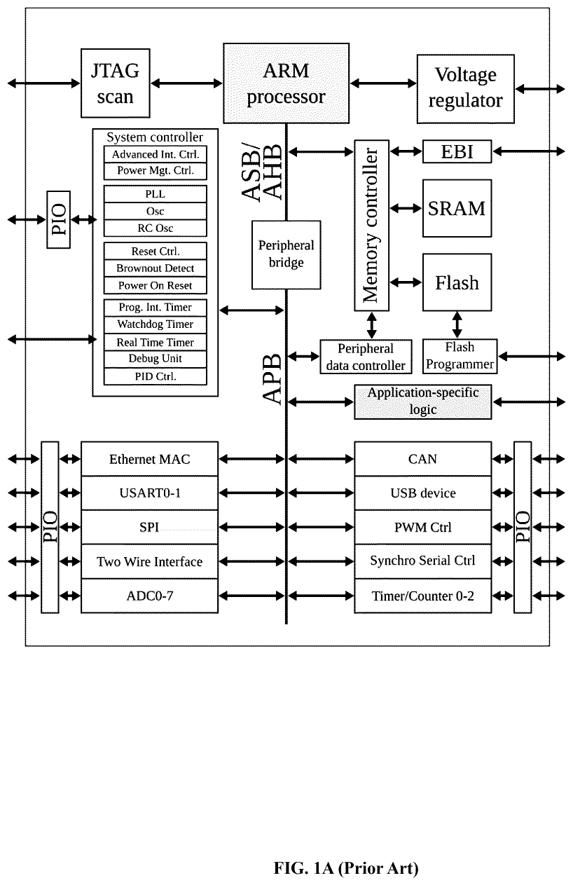

FIG. 1B illustrates present working of a computer system 01. Any peripheral device, for example, 03 and 04 is used by CPU 07 of the computer system 01 by mapping the peripheral device's (03 or 04) internal memory (not shown) to CPU's 07 main memory 02. And hence, when mapped memory is accessed by CPU 07, the request is routed through internal PCIe system 06 to the connected peripheral device (03 or 04) and the peripheral device (03 or 04) is accessed. This is how all the peripheral devices (03 or 04) are interacted and used by the main CPU 07 of computer system 01. As illustrated, mapping the internal memory (not shown) of the peripheral device (03 or 04) to the main memory 02 of the system's 01 CPU 07, with the help of PCIe subsystem 06 and DMA controller 08 within the CPU 07, is the method to recognize and to interact with the peripheral device (03 or 04).

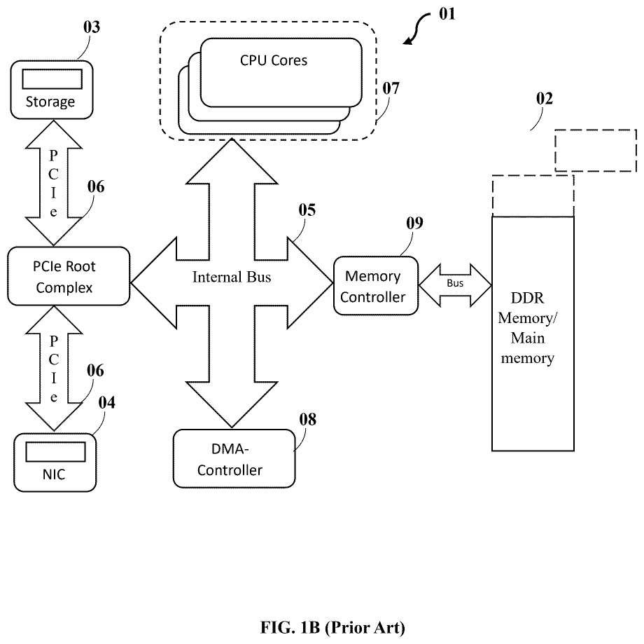

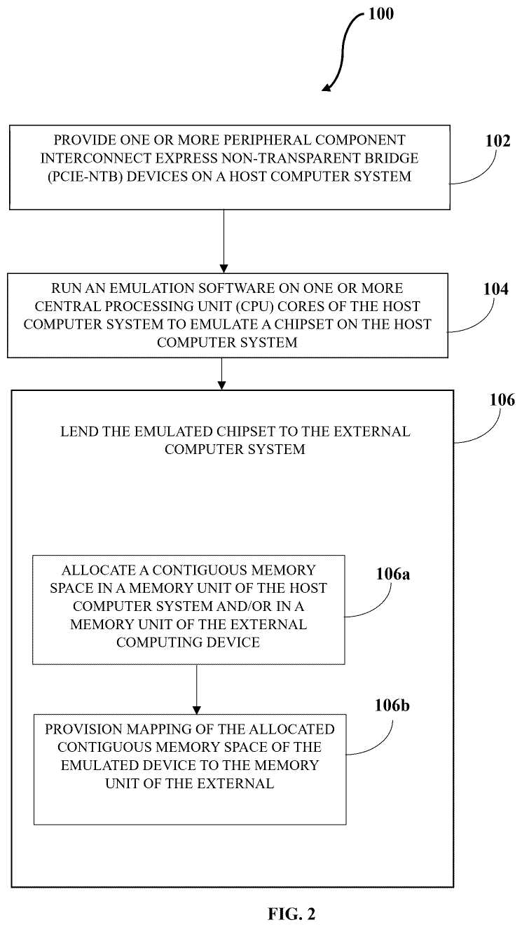

FIG. 2 illustrates a method 100 for provisioning more than one emulated device from a computer system 200, for example, a host computer system 200. FIG. 3 illustrates a block diagram of a system 210 for provisioning more than one emulated device from a computer system 200 and a block diagram of an external computer system 220, where both the computer system 200 and the external computer system 220 are connected through a peripheral component interconnect express (PCIe) connection 218. The emulated device is for example, an emulated “chipset on the computer system” (CoS) 210. As used herein, the word “chipset” in the term “chipset-on-the-computer-system” refers to an input/output (IO) controller device and the term “computer-system” refers to the host computer system 200. As used herein, the host computer system 200 and the external computing device 220 are selected from a group comprising a computer, a server, a portable computing device, etc.

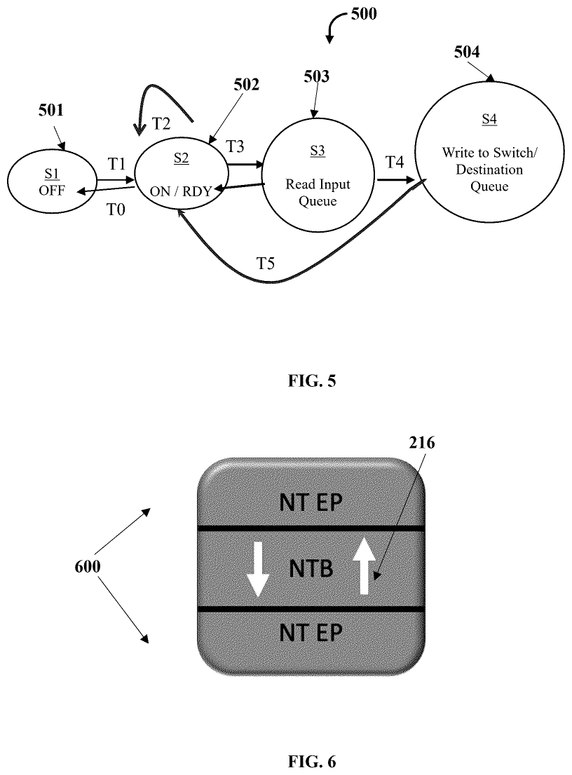

CoS may be a dedicated server system that is connected to other server systems, for example, a compute system 200 through a PCIe connection 218 via PCIe-NTB device ports 216 to the external computer system 220. CoS would enable PCIe-Non-Transparent Bridge (NTB) at the PCIe port and hence connected servers, for example, the external compute system/server 220, and dedicated system, for example, the host computer system 200, itself would appear as PCIe end-points (PCIe-EP) on both sides of PCIe-NTB 216. These are called NT-End-Points (NTEP) 600, as shown in FIG. 6. These NTEPs 600 are memory exchange controllers and hence, the physical memory of connected systems i.e., the host computer system 200 and the external computer system/server 220, can be made visible and shared to each other. Since, every device (PCIe EP) is accessed, controlled/managed by reading from & writing into the memory of the device, the shared memory can be device memory i.e., the memory of the chipset being emulated. As a result, a connected server i.e., the external computer system/server 220, can see a device memory or ‘a device’ as a directly attached device from CoS. CoS can provision more than one device/ASIC through this and hence, it is called Chipset-on-a-System (CoS).

The method 100 comprises providing 102 one or more peripheral component interconnect express non-transparent bridge (PCIe-NTB) devices 216 (216a, 216b and 216c) on the host computer system 200. Each of the PCIe-NTB devices 216a, 216b and 216c comprise a peripheral component interconnect express (PCIe) port (not shown) that is configured to connect to the external computer system 220, using one or more PCIe cables 218.

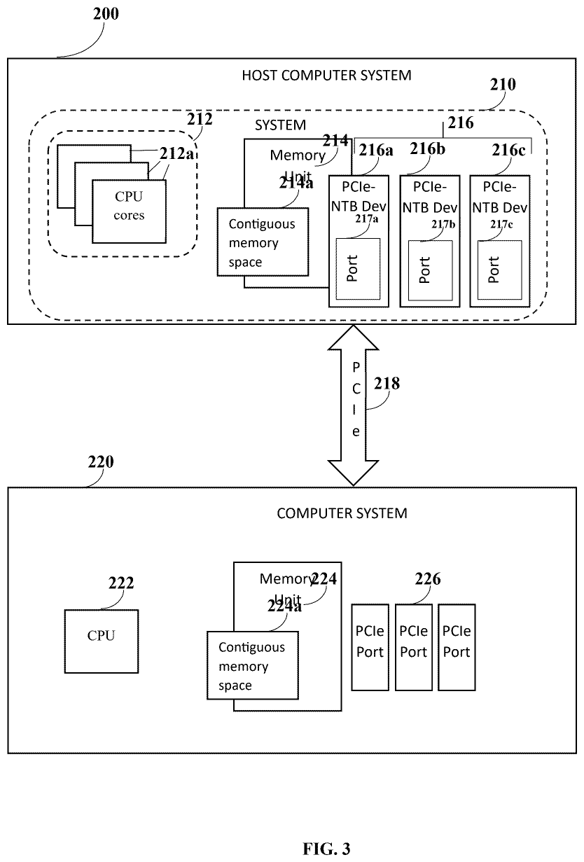

FIG. 4 exemplarily illustrates a prior art PCI Express topology, displaying the position of a PCIe Root Complex. As used herein, a PCIe Root Complex is a root complex device in a PCI Express (PCIe) system, that connects the CPU and memory subsystem to a PCIe switch fabric composed of one or more PCIe or PCI devices. A PCIe fabric refers to a network of interconnected devices that communicate using the PCIe protocol. Similar to a host bridge in a PCI system, the root complex generates transaction requests on behalf of the CPU, which is interconnected through a local bus. In other words, functionalities of the root complex and host bridge are similar. Root complex functionality may be integrated in the chipset and/or the CPU, for example, the CPU 212 of the host computer system 200, or the CPU cores 212a. A root complex may contain more than one PCI Express port and multiple switch devices can be connected to ports on the root complex or cascaded.

A host bridge connects the processor, for example, the CPU 212 of the host computer system 200, or the CPU cores 212a to peripheral components, allowing the processor to directly access main memory, for example, the memory unit 214 or the memory unit 224, without interference from other PCI bus masters. The host bridge also provides data access mappings between the CPU 212 and peripheral IO devices connected via a PCIe bridge. It does this by mapping each peripheral I/O device to the host address domain, so the processor can access the device through programmed I/O. Programmed Input/Output (PIO) is a way of moving data between devices in a computer, for example, host computer 212 in which all data must pass through the CPU 212. The host bridge also maps system memory to the PCI address domain, so the PCI I/O device can access the host memory as a bus master. The PCIe bridge is used to link the I/O devices that use the PCI or PCI-X interface to provide a PCIe connection to the CPU 212, SoC, or root complex. PCIe bridges are typically installed in PCIe adapter cards, embedded computing, and motherboards so that PCI/PCI-X devices, PCI/PCI-X expansion slots, and even USB bus interfaces can still work with the serial architecture of PCIe.

By introducing latest generation PCIe-NTB device fabric switch, within the CoS, it is possible to connect more than two compute systems together. A PCIe-NTB device fabric switch is a device that uses Non-Transparent Bridging (NTB) technology to connect devices in different switch partitions and form a PCIe Fabric. The current and future generations of PCIe's speed and data bandwidth allows us to have grid of many computer systems connected with very wide data bandwidth and with very low latency.

The method 100 further comprises running 104 an emulation software on one or more central processing unit (CPU) cores 212a of the host computer system 200 to emulate a chipset on the host computer system 200 (CoS). The emulated chipset emulates functionalities of an input/output (IO) controller device. The method 100 further comprises lending 106 the emulated CoS to the PCIe-NTB device 216 connected external computer system 220. The step of lending 106 the emulated chipset to the PCIe-NTB device 216 connected external computer system 220 comprises allocating 106a a contiguous memory space (214a and/or 224a) in a memory unit 214 of the host computer system 200 and/or in a memory unit 224 of the external computer system 220. This means that the contiguous memory space (214a and/or 224a) is allocated either in the memory unit 214 of the host computer system 200 as contiguous memory space 214a, in the memory unit 224 of the external computer system 220 as contiguous memory space 224a or as shared contiguous memory space (214a and/or 224a) between both the host computer system 200 and the external computer system 220. The contiguous memory space (214a and/or 224a) is for use by the emulated chipset. The step of lending 106 the emulated chipset to the PCIe-NTB device 216 connected external computer system 220 further comprises provisioning 106b mapping of the allocated contiguous memory space (214a and/or 224a) of the emulated chipset to the memory unit 224 of the external computer system 220 for configuration and use of the emulated chipset by the external computer system 220. The provisioned memory will be mapped to connected computer system's 220 main memory 224 and hence a device would be ‘visible’ to use.

In an embodiment, the method 100 further comprises running one or more un-swapped finite state machine processes on the CPU cores 212a to provide a hardware functionality and share the allocated contiguous memory space (214a and/or 224a) with the connected external computer system 220 via the PCIe-NTB device port 216. In an embodiment, the hardware functionality provided by an un-swapped finite state machine process can be functionality of a non-volatile memory express (NVMe) controller, a smart network interface controller, a network switch, a storage virtualization controller, etc.

A system 210 for provisioning more than one emulated device from a computer system (CS) 200 comprises the one or more peripheral component interconnect express non-transparent bridge (PCIe-NTB) devices 216 (216a, 216b and 216c). Each of the one or more PCIE-NTB devices 216 (216a, 216b and 216c) comprise a peripheral component interconnect express (PCIe) port (not shown) configured to connect to the external computer system 220, using PCIe cables 218. The system 210 further comprises one or more central processing unit (CPU) cores 212a running a software, for example, an emulation software to emulate multiple chips to lend the emulated chips through the PCIe-NTB device 216 connected external computer system 220. The system 210 further comprises a memory unit 214 operably and communicatively coupled to the plurality of CPU cores 212a and configured to store computer program instructions executable by the plurality of CPU cores 212a. The computer program instructions comprise instructions corresponding to the emulation software and the memory unit 214 comprises a contiguous memory space. The contiguous memory space is for use by the emulated chipset.

In an embodiment, the contiguous memory space 214a of the computer system 210 is shared between more than one computer system via PCIe-NTB devices' port. In an embodiment, the emulated chips are recognized through their contiguous memory space 214a in the memory unit 214 of the host system 200 that gets mapped to the memory unit 224 of the external computer system 220. In another embodiment, the emulated chipset may utilize the contiguous memory space 224a in the memory unit 224 of the external computer system 220. In another embodiment, the emulated chipset may utilize the contiguous memory space (214a and/or 224a) in the memory units (214 and/or 224) of both the system 210 and the external computer system 220.

The method 100 and system 210 disclosed herein utilizes resources from the host computer system 200 and resources from the external computer system 220 to provide a virtual device that functions as a Chipset-on-a-System (CoS). The word “chipset” in the “CoS” being set of chips/devices 210 and the word “System” in the “COS” being the host computer system 200. CoS is a new technology approach to improve the way of networking and computing data without having to rewrite the existing applications and without changing system deployments. CoS leverages the existing PCIe technology to improve the data life cycle and networking within a Data Center (DC).

The method 100 disclosed herein may utilize existing resources of the host computer system 200. The system 210 may utilize the PCIe ports, PCIe-NTB devices 216, CPU cores 212a and memory unit 214 of the host computer system 200. In an embodiment, when the contiguous memory space 224a is shared with the external computer system 220, the method 100 disclosed herein may utilize existing resources of the external computer system 220. The system 210 may utilize the PCIe ports 226 and the memory unit 224 of the external computer system 220, and the PCIe connection 218 between the host computer system 200 and the external computer system 220.

The method 100 and system 210 disclosed herein creates a virtual device by having input and output physical PCIe connection to memory of the virtual device i.e., the system 210. As explained in the above paragraphs, a H/W device is recognized by the CPU 212 by the PCIe connection 218 and by mapping the memory of the H/W device through PCIe connection 218 to CPU's 212 address space. We will have two computer systems i.e., 200 and 220 connected by PCIe's NTB device 216a, 216b, or 216c that lets connected computer systems' CPUs 212 and/or 222 to share their memory 214 and/or 224 over PCIe-NTB 216a, 216b, or 216c. As used herein, an address space, in computing defines a range of discrete addresses that are available for storing data. Furthermore, each of these discrete addresses may correspond to a network host, a peripheral device, a disk sector in a storage disk, a memory cell or other logical or physical entity. Address space is important for programming because it allows software to interact with specific memory locations or input/output devices. It can also be used to optimize software, improve security, and ensure efficient communication in systems that are distributed or networked.

One of the systems or both i.e., the host computer system 200 and/or the external computer system 220, would allocate contiguous memory space (214a and/or 224a) in the memory unit 214 of the host computer system 200 and/or in the memory unit 224 of the external computer system 220. This contiguous memory space 214a and 224a is part of the address space of the host computer memory 200 and the external computer system 220. This allocated contiguous memory space (214a and/or 224a) is for a type of device, for example, a non-volatile memory express (NVMe) controller, a smart network interface controller, a network switch, a storage virtualization controller, etc., that the system 210 wants to emulate. The host computer system 200 that hosts the system 210 that wants to emulate another device may be called a ‘Lender’ and the chip or device being emulated may be called the ‘emulated device’. A ‘Lender’ can configure the allocated contiguous memory space (214a and/or 224a) as “control & config space” of the ‘emulated device/chip’ and Input/Output “IO” space of the ‘emulated chip/device’. A “Lender” can make this contiguous memory space (214a and/or 224a) visible to another PCIe connected compute system, for example, the external computer system 220, if the “Lender” decides to ‘lend’ ‘emulated device’ to the external computer system 220 that is connected through the PCIe connection 218. In an embodiment, the contiguous memory space (214a and/or 224a) is assigned to the emulated device.

The external computer system 220 is a peer system to the “Lender” 220. The external computer system/server 220 receives the ‘emulated device's’ contiguous memory space (214a and/or 224a) and maps the memory space (214a and/or 224a) to its own memory space in the memory 224. Therefore, the contiguous memory space (214a and/or 224a) from an ‘emulated device’ in the ‘Lender’ system 220, is mapped to the Peer system's memory 224 and hence the emulated device is seen as a real physical device by the Peer system i.e., the external computer system/server 220. The Peer system 220 is now called, a ‘borrower’ 220. As explained above, in an embodiment, the contiguous memory space 224a is allocated in the memory unit 224 of the external computer system 220. In such instance, the contiguous memory space 224a of the “emulated device” is mapped to the address space of the peer compute server/system 220, even though both the contiguous memory space 224a of the “emulated device” and the address space of the peer compute system/server 220 are both present in the memory 224 of the external computer system 220.

The “emulated device” may be termed as a ‘ghost’ device on the peer system/server 200. However, from the “borrower's” 220 perspective, the ‘ghost’ device is a real physical device as it is directly connected to the borrower 220 over the PCIe connection 218, as it should be.

All functionalities and characteristics of the ‘emulated device’ is implemented by the “Lender” 200 by having either a ‘Finite State Machine’ implemented in software on a dedicated core 212a or a queue manager software that polls the queue for the input/output request, for device emulation. FSM responds to config, control & IO request from the borrower 220 by getting PCIe interrupts/MSIx and other PCIe-NTB mechanisms such as doorbell registers. Also, doorbell registers are frequently used on PCI/PCIe devices by a host to inform a device that there is new work queued and available for processing.

The following paragraphs illustrate the steps to implement a chipset that is not physically present within the motherboard of either the host computer system 200 or the external computer system 220:

Device Lender (Host Computer System 200 with PCIe-NTB Device 216)
1. The host computer system 200 that implements the system 210 also implements a PCIe configuration page/PCIe configuration space in compliance with one of the PCIe generations. PCI configuration page is the underlying way that the PCIe perform auto configuration of devices (PCIe endpoints) inserted into their PCI bus. The PCI configuration page is a memory region that is used to detect and configure PCI devices. It is a standardized set of registers, accessible via PCIe bus, that provide a way for the host computer system 200 and/or the external computer system 220 to identify and control the PCI devices.
2. Reserve compute power i.e., CPU cores 212a of the CPU 212 of the host computer system 200 to adequately service the device configuration of the emulated chipset & IO requests and responses of the emulated input/output (IO) controller device/chipset.
3. Allocate memory section i.e., contiguous memory space (214a and/or 224a) in the memory unit 214 of the host computer system 200 and/or in the memory unit 224 of the external computer system 220 to host this PCIe configuration page/PCIe configuration space. The PCIe configuration page/PCIe configuration space is also called a PCIe Configuration Space header or PCIe header of an IO device, for example, the emulated input/output (IO) controller device/chipset.
4. Allocate a memory i.e., contiguous memory space (214a and/or 224a) in the memory 214 of the host computer system 200 and/or in the memory unit 224 of the external computer system 220 to host memory mapped emulated input/output (IO) controller device/chipset.
5. Publish the PCIe configuration page/PCIe configuration space/PCIe header of the mapped emulated input/output (IO) controller device/chipset to the PCIe-NTB connected external computer system/server 220.

### Device Borrower (the External Computer System 220 Connected Via a PCIe-NTB Device Through a PCIe Connection)

1. Connected external computer system 220 (through a PCIe-NTB device) can access the PCIe header of the published emulated input/output (IO) controller device/chipset through NTB since, NTB helps to ‘see’ the remote memory i.e., the contiguous memory space (214a and/or 224a) as local memory when lender publishes the PCIe header of the emulated input/output (IO) controller device/chipset.
2. The appropriate driver for the published emulated input/output (IO) controller device/chipset can be invoked to access the published input/output (IO) controller device/chipset.
3. Driver software (S/W) will interact with Configuration & Status registers of the PCIe header by reading PCIe headers to get more information on the input/output (IO) controller device/chipset.
4. Borrower i.e., external computer system 220 may start using the input/output (IO) controller device/chipset as usual as it is visible as a ‘directly attached IO controller device/chipset as per PCIe setup in the external computer system 220.

The borrower 220 configures the ‘ghost’ device which is directly connected to the borrower 220 through the PCIe connection 218, through writing to and reading from the memory mapped config & control space i.e., the contiguous memory space (214a and/or 224a). When the memory is accessed, the lender 210 gets the request through the PCIe-NTB device 216 mechanisms, and the FSM on the lender 210 responds by means of PCIe-NTB device 216 mechanisms or by writing to/reading from the configured contiguous memory space (214a and/or 224a) of the “ghost”/emulated IO device/chipset.

Thus, with the help of PCIe-NTB, software FSM on dedicated core(s) 212a and right amount of contiguous memory space (214a and/or 224a), a complex H/W device like Ethernet Network Switch, Fibre Channel Network Switch, Storage Virtualization IO Controllers, NVMe & Network Interface Controllers would be implemented.

Furthermore, since a set of silicon chips are implemented/emulated from a remote host computer system 200 to implement the functionality of an IO controller device/chipset, the system 210 may be called the ‘Chipset-on-System’ and CoS in short.

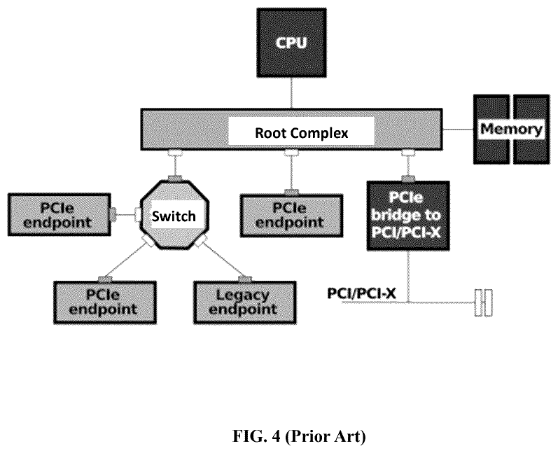

FIG. 5 exemplarily illustrates a Finite State Machine (FSM) 500 running in one or more cores 212a of the central processing unit (CPU) 212 of the system 210. In an embodiment, the one or more cores 212a may be dedicated cores of the CPU 212 used for running the FSM 500. The one or more CPU cores 212a may be made available when there is a need to run the FSM 500. At other times, the CPU cores 212a may be used for running routine CPU 212 operations. The FSMs 500 may implement hardware functionality comprising the functionality of a non-volatile memory express (NVMe) controller, a smart network interface controller, a network switch, a storage visualization controller. As shown in FIGS. 5, S1, S2, S3, and S4 are states represented by circles, and T1, T2, T3, T4, and T5 are transitions depicted using arrows. FSM 500 maintains various states of a device such as off, on, functional and degraded states. Essentially, in every state a certain function of the device being simulated, for example, a Network Interface Controller, by the FSM 500, is executed. This improves the data throughput at very low latency. In FIG. 5, the state S1 501 represents the OFF state of the Network Interface Controller, the state S2 502 represents the “ON” or “RDY” i.e., “ready” state, and the state S3 503 represents the “Read Input Queue” to read the incoming data and transfer it to the contiguous memory space (214a and/or 224a). The state S4 504 represents the “Write to Switch/Destination Queue” where the data in the contiguous memory space (214a and/or 224a) is transmitted to a destination device, for example, the external computer system 220 or entered in a destination queue for transmitting the data to the external computer system 220 at a later time.

Consider an example of (Ethernet) Network Interface Cards (NIC) of modern-day computer systems. The NICs are Smart NICs which process data before the data reaches the computer system in-order to reduce the workload on the CPU of the computer system. The computer system, as used herein is selected from a group comprising a computer, a server, a portable computing device, etc. Hence, a System-on-a-Chip (SoC) contains, multiple power efficient CPU cores, controllers such as DDR, PCIe, DMA, micro-controllers, cache memory, and on chip memory. A firmware stack is also required. A firmware is the foundation of a computer's software stack and is used by hardware to perform basic operations and run applications. A firmware is a type of software that's embedded into hardware devices' memory, and is often permanent in nature. Firmware acts as a bridge between hardware and software, enabling other application softwares to run on hardware.

Consider another example of a Redundant Array of Independent Disks (RAID) controller which is also called a storage virtualization controller. The RAID controller/storage virtualization controller implements data protection. To run a Data Volume manager, SoC has many CPU compute cores, higher & faster cache memory and wider bandwidth media access controller such as SAS. The Data Volume Manager identifies storage bottlenecks and allows users to migrate data to other devices, even while applications and their data remain on-line and available. Use Volume Manager to balance IO loads and to stripe data across multiple storage devices.

The system 210 and method 100 for provisioning more than one emulated device from a computer system (CS) 200 simplifies such complex System-on-A-Chip (SoC) operations on the HBA's by separating the media access controller and utilizes the existing controllers such as memory unit 214, DMA (not shown), cache memory (not shown), CPU 212 of the host computer system 200 to run the software stack on the system 210.

Benefits of the system 210 and method 100 comprise:
1. Total Cost of Ownership (TCO=CapEx+OpEx) of a data center (DC) is reduced, since many IO controller devices can be implemented on the fly on the system 100 to provide virtual machines with direct attached devices, on the borrower i.e., the external computer system 220.
2. A DC is designed based on rack scaled architecture and having a couple of CoS servers per rack, improves the capability and increases the capacity of the DC by many folds, based on the compute power of interconnected systems used in the DC.
3. The power consumption of the overall DC is reduced by increasing the capacity of the existing servers to many folds.
4. Cooling effort of the DC gets reduced as CoS increased the capacity of the servers in DC.

FIG. 6 illustrates a peripheral component interconnect express (PCIe) non-transparent bridge (NTB) PCIe-NTB device 216. In an embodiment, the PCIe-NTB device 216 is PCIe Generation 6.0 compliant and is backward compatible to work with older generation of PCIe ports, protocols, and cables. As illustrated in FIG. 6, the PCIe-NTB device 216 comprises two non-transparent end-points (NT-EBs).

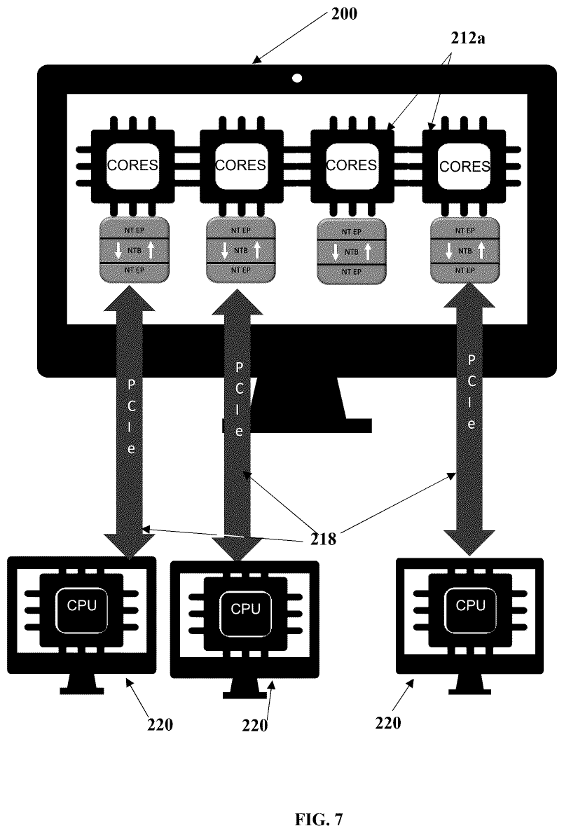

FIG. 7 illustrates the scalability of the chipset-on-a-system. A Chipset on System could have more than one port to connect to external compute systems/hosts. Each port is backed by PCIe-NTB device to provision more than one IO controller chip through the port.

The foregoing examples and illustrative implementations of various embodiments have been provided merely for explanation and are in no way to be construed as limiting of the present invention. Dimensions of various parts of the chipset-on-a-system disclosed above are exemplary, and are not limiting of the scope of the embodiments herein. While the present invention has been described with reference to various illustrative implementations, drawings, and techniques, it is understood that the words, which have been used herein, are words of description and illustration, rather than words of limitation. Furthermore, although the present invention has been described herein with reference to particular means, materials, techniques, and implementations, the present invention is not intended to be limited to the particulars disclosed herein; rather, the present invention extends to all functionally equivalent structures, methods and uses, such as are within the scope of the appended claims. It will be understood by those skilled in the art, having the benefit of the teachings of this specification, that the present invention is capable of modifications and other embodiments may be effected and changes may be made thereto, without departing from the scope and spirit of the present invention.

I claim:

1. A method for provisioning more than one emulated device from a host computer system, comprising:
providing one or more peripheral component interconnect express non-transparent bridge (PCIe-NTB) devices on the host computer system, wherein each of the one more PCIE-NTB devices comprise a peripheral component interconnect express (PCIe) port configured to connect to an external computer system, using one or more PCIe cables;
running an emulation software on one or more central processing unit (CPU) cores of the host computer system to emulate a chipset on the host computer system, wherein the emulated chipset emulates functionalities of an input/output (IO) controller device; and
lending the emulated chipset to the external computer system connected via the PCIe-NTB device, comprising:
allocating a contiguous memory space in a memory unit of the host computer system and/or in a memory unit of the external computer system, wherein the contiguous memory space is for use by the emulated chipset; and
provisioning mapping of the allocated contiguous memory space of the emulated chipset to the memory unit of the external computer system for configuration and use of the emulated chipset by the external computer system.

2. The method of claim 1 further comprising running one or more un-swapped finite state machine processes on the CPU cores to provide a hardware functionality using the emulated chipset and share the allocated contiguous memory space with the external computer system connected via the PCIe-NTB device.

3. The method of claim 2, wherein the hardware functionality comprises functionality of one of a non-volatile memory express (NVMe) controller, a smart network interface controller, a network switch, and a storage visualization controller.

4. A system for provisioning more than one emulated device from a host computer system, comprising:
one or more peripheral component interconnect express non-transparent bridge (PCIe-NTB) devices, wherein each of the one or more PCIE-NTB devices comprise a peripheral component interconnect express (PCIe) port configured to connect to an external computer system, using one or more PCIe cables;
one or more central processing unit (CPU) cores running an emulation software to emulate a chipset on the host computer system to lend the emulated chipset to the external computer system connected via the PCIe-NTB device, wherein the emulated chipset emulates functionalities of an input/output (IO) controller device;
a memory unit operably and communicatively coupled to the plurality of CPU cores and configured to store computer program instructions executable by the plurality of CPU cores, wherein the computer program instructions comprise instructions corresponding to the emulation software, wherein the memory unit comprises a contiguous memory space, and wherein the contiguous memory space is for use by the emulated chipset;

5. The system as claimed in claim 4, wherein the contiguous memory space is allocated in the memory unit of the external computer system and/or the memory unit of the computer system.

6. The system as claimed in claim 4, wherein the computer program instructions comprise instructions to implement one or more un-swapped finite state machine processes on the CPU cores, wherein the one or more un-swapped finite state machine processes provide a hardware functionality using the emulated chipset and share the allocated contiguous memory space with the external computer system connected via the PCIe-NTB device.

7. The system as claimed in claim 6, wherein the hardware functionality comprises functionality of one of a non-volatile memory express (NVMe) controller, a smart network interface controller, a network switch, and a storage visualization controller.
